(19) United States
(12) Patent Application Publication
(10) Pub. No.: US 2007/0282230 A1
(43) Pub. Date: Dec. 6, 2007

(54) Systems and methods for applying reversed sequence pressure to control edema flow

(75) Inventors: Victor Valderrabano, Oberwil (CH); David C. Hargrave, Madison, NJ (US)

Correspondence Address: ROPES & GRAY LLP;PATENT DOCKETING 39/41, ONE INTERNATIONAL PLACE, BOSTON, MA, 02110-2624, US

(73) Assignee: DJO, LLC, Vista, CA (US)

(21) Appl. No.: 11/639,581

(22) Filed: Dec. 15, 2006

Related U.S. Application Data
(60) Provisional application No. 60/751,091, filed on Dec. 15, 2005.

(51) Int. Cl. A61H 9/00

(52) U.S. Cl. 601/152

(57) ABSTRACT

The systems and methods described herein, include, among other things, orthopedic appliances and methods of applying therapy to limb of a patient for the purpose of reducing edema. In one aspect, the invention provides a therapy system that may be fitted over a patient's limb about a joint for the purposes of treating limb injury by reducing or milking edema. In other aspects, the invention provides for systems and methods that may be adapted to provide intermittent massaging of lymph fluid through the lymphatic vessels in a direction toward the heart, which is toward the center of a patient's torso and away from the patient's affected limb.

### CROSS-REFERENCE TO RELATED APPLICATIONS

This application claims priority to and the benefit of U.S. Provisional Patent Application Ser. No. 60/751,091, filed on Dec. 15, 2005 and entitled “Edema Flow with Reversed Sequence Pressure Application,” the entire contents of which are incorporated herein by reference.

### BACKGROUND

Edema is the abnormal accumulation of fluid in connective tissue. Edema typically includes swelling of a user's extremity and results from a combination of passive venous congestion and salt and water retention. Edema may be systemic or localized to a particular region of the body. Edema is sometimes also called dropsy or anasarca. Edema can arise in response to injury or post-operatively, when fluid is released by inflammatory cells and other mechanisms. Edema can also result from the abnormal function or other impairment of the lymph vessels. Fluid accumulation in the tissue of the limbic extremities, for example the ankle or foot, is a physical manifestation associated with a number of different edemic conditions. For example, edema can arise in response to an injury of an extremity, such as an ankle sprain. Edema, particularly that Edema localized in the lower extremities, can be painful and can act to restrict normal circulation, wound healing, injury rehabilitation, and can increase the likelihood of infection.

Prior art devices for treating edema often include the use of a therapy system applied to the ankle or foot to provide a compression for controlling the edema, for example the edema that might arise from either an inversion or eversion sprain or other injury. One such edema-control therapy system is disclosed in U.S. Pat. No. 4,590,932 issued to Wilkerson, incorporated herein by reference in its entirety. The compression applied by the Wilkerson therapy system helps prevent fluid from accumulating to a substantial degree in the area of the trauma and to reverse initial accumulation at that site. This is understood to have a beneficial effect on the patient and the acceleration of the healing process. Other exemplary systems are disclosed in U.S. Pat. No. 5,976,099 issued to Kellogg, incorporated herein by reference in its entirety.

Although the systems described in the art can work, their relatively insensitive compression protocols render them suboptimal. There remains a need for improved systems and methods that reduce edema and reduce the accumulation of fluid and swelling at the sight of a trauma.

### SUMMARY

The systems and methods described herein, include, among other things, orthopedic appliances and methods of applying therapy to the limb of a patient for the purpose of reducing edema. In one aspect, the invention provides a therapy system that may be fitted over a patient's limb about a joint for the purposes of treating limb injury by reducing or milking edema. In other aspects, the invention provides for systems and methods that may be adapted to provide intermittent massaging of lymph fluid through the lymphatic vessels in a direction toward the heart, which is toward the center of a patient's torso and away from the patient's affected limb.

More particularly, in one aspect, the systems and methods described herein include a brace for applying therapy to a limb. The brace comprises a rigid outer shell, having an inner surface, adapted to be applied over proximal and distal portions of a limb. In certain embodiments, the rigid shell is adapted to be applied over the proximal and distal portions of a leg about at least one joint, e.g., a knee, an ankle, or an elbow. The brace also includes one or more bladder assemblies. A bladder assembly includes one or more inflatable fluid bladders that are attached to the inner surface of the rigid outer shell along a portion of the limb. A plurality of inflatable fluid bladders may be used. In certain embodiments, a proximal bladder assembly is used and includes a plurality of fluid bladders positioned along a proximal portion of the patient's limb. A distal bladder assembly may also be used and includes one or more inflatable fluid bladders positionable along a distal side of the limb. The brace may be configured to have a plurality of proximal bladder assemblies and/or a plurality of distal bladder assemblies, with one or more of such assemblies having a plurality of inflatable fluid bladders.

The one or more inflatable fluid bladders in the proximal and distal bladder assemblies are positioned so as to help facilitate the milking of edema away from the site of an injury. In certain embodiments, the bladders are positioned in the proximal and distal assembly at least partially transverse to each other. An inflatable fluid bladder in the proximal bladder assembly may overlap another inflatable fluid bladder in the proximal bladder assembly. In certain embodiments, each of the plurality of inflatable fluid bladders in the proximal bladder assembly are of different dimensions. An inflatable fluid bladder in the proximal bladder assembly may be positioned inside another inflatable fluid bladder in the proximal bladder assembly. Each of the plurality of inflatable fluid bladders in the proximal bladder assembly may be attached to each other using at least one of gluing, stitching and zipping.

In certain embodiments, a plurality of inflatable fluid bladders in the distal bladder assembly are positioned at least partially transverse to each other. An inflatable fluid bladder in the distal bladder assembly may overlap another inflatable fluid bladder in the distal bladder assembly. In certain embodiments, each of the plurality of inflatable fluid bladders in the distal bladder assembly are of different dimensions. An inflatable fluid bladder in the distal bladder assembly may be positioned inside another inflatable fluid bladder in the distal bladder assembly. Each of the plurality of inflatable fluid bladders in the distal bladder assembly may be attached to each other using at least one of gluing, stitching and zipping.

In certain embodiments, one or more inflatable fluid bladders substantially circumferentiates the limb. In certain embodiments, one or more of a plurality of inflatable fluid bladders in at least one of a proximal and distal bladder assemblies substantially circumferentiates the limb.

In certain embodiments, the brace comprises at least one conduit in communication with at least one inflatable fluid bladder for providing fluid. At least one of the plurality of inflatable fluid bladders in at least one of the proximal and distal bladder assemblies may include an inflation port for receiving a conduit. The brace may include or be connected to a fluid source for supplying fluid to at least one of the plurality of inflatable fluid bladders in at least one of the proximal and distal bladder assemblies. In such embodiments, the fluid source includes a fluid reservoir in fluid communication with the brace through at least one of an external and/or internal pump.

In another exemplary embodiment, the systems and methods described herein include an inflatable bladder assembly for applying therapy to a limb. The inflatable bladder assembly is positioned in the vicinity of an anatomical region of a limb and configured to apply pressure to the anatomical region. The bladder assembly includes a first inflatable bladder, a second inflatable bladder that is positioned adjacent to the first inflatable bladder, and a third inflatable bladder that is positioned adjacent to the second inflatable bladder. The first, second and third inflatable bladders are positioned with respect to each other so as to facilitate edema milking. In certain implementations, the bladders are at least partially transverse to each other. In certain embodiments, a substantial portion of the distal end of the bladder assembly includes the first inflatable bladder and a substantial portion of the proximal end of the bladder assembly includes the third inflatable bladder.

In certain embodiments, the first inflatable bladder is smaller than the second inflatable bladder and the second inflatable bladder is smaller than the third inflatable bladder. The first, second and/or third inflatable bladders may be physically coupled such that the second inflatable bladder overlaps a portion of the first inflatable bladder and/or the third inflatable bladder overlaps a portion of the second inflatable bladder. In other embodiments, the first inflatable bladder is positioned inside the second inflatable bladder and/or the second inflatable bladder is positioned inside the third inflatable bladder. At least two of the first, second and third inflatable bladders may be attached to each other using gluing, stitching, zipping or other suitable attachments.

In another aspect, the systems and methods described herein include methods for applying therapy to a limb. The methods generally include applying a multi-chambered bladder assembly about a limb and applying sequential compression and decompression to the limb by inflating and deflating the chambers in a direction from a distal portion of the limb to the proximal portion. In certain implementations the methods comprise applying a proximal bladder assembly on a proximal side of the limb about a joint, applying a distal bladder assembly on a distal side of the limb about a joint and applying compression to a limb by first inflating the proximal bladder assembly and then inflating the distal bladder assembly. The therapy may be applied to at least one of a foot, lower leg, upper leg, arm, wrist, thigh, hand and finger. In certain embodiments, the methods comprise applying at least one of the proximal and distal bladder assemblies to at least one of a lower calf area, a mid-calf area, an upper calf area, a heel region, an ankle region in the area of the maleolus, an Achilles area, a distal metatarsal area, a navicular region, a region proximal to a navicular region and distal to a maleolus region.

In certain embodiments, the methods comprise repeating the application of compression until edema in a patient's limb is reduced to a target level. In certain embodiments, this target level is achieved after a number of cycles of compression are reached, a time limit is reached, a user-selected stopping point is reached, or a therapist selected stopping point is reached.

In certain embodiments, a first bladder assembly is positioned along a patient's limb and has a plurality of inflatable bladders. The first bladder assembly may include three or more inflatable fluid bladders. In such embodiments, inflating the first bladder assembly includes first inflating one or more of the plurality of inflatable bladders in a distal portion of the first bladder assembly and then inflating one or more of the plurality of inflatable bladders in a proximal portion of the bladder assembly.

In certain embodiments, a second bladder assembly is also used and is positioned distal to the first bladder assembly along a portion of the limb. The distal bladder assembly also includes a plurality of inflatable bladders. The distal bladder assembly may include three or more inflatable fluid bladders. In such embodiments, inflating the distal bladder assembly includes first inflating one or more of the plurality of inflatable bladders in distal portion of the distal bladder assembly and then inflating one or more of the plurality of inflatable bladders in proximal portion of the distal bladder assembly.

In certain embodiments, the methods comprise deflating the proximal bladder assembly after inflating the proximal bladder assembly. In such embodiments, the methods further comprise deflating the proximal bladder assembly during inflating the distal bladder assembly. The methods may also comprise deflating the proximal bladder assembly after inflating the distal bladder assembly.

In certain embodiments, the methods comprise deflating the distal bladder assembly after inflating the distal bladder assembly. In such embodiments, the methods comprise deflating the proximal bladder assembly after deflating the distal bladder assembly. In certain embodiments, the methods comprise first deflating the proximal bladder assembly and then deflating the distal bladder assembly.

In certain embodiments, the methods include first deflating one or more of a plurality of inflatable bladders in a distal portion of a proximal bladder assembly and then deflating one or more of a plurality of inflatable bladders in a proximal portion of a proximal bladder assembly. In certain embodiments, deflating the proximal bladder assembly includes simultaneously deflating substantially all of the plurality of inflatable bladders.

In certain embodiments, the methods include first deflating one or more of a plurality of inflatable bladders in a distal portion of a distal bladder assembly and then deflating one or more of a plurality of inflatable bladders in a proximal portion of a distal bladder assembly. In certain embodiments, deflating the distal bladder assembly includes simultaneously deflating substantially all of the plurality of inflatable bladders.

### BRIEF DESCRIPTION OF THE DRAWINGS

The following figures depict certain illustrative embodiments of the systems and methods disclosed herein, in which like reference numerals refer to like elements. These depicted embodiments may not be drawn to scale and are to be understood as illustrative of the invention and not as limiting in any way.

FIG. 1 depicts an ankle brace for providing therapy to a person's limb.

FIG. 2 depicts a massage process for incrementally massaging a user's limb.

FIG. 3 depicts a more detailed view of the ankle brace of FIG. 1.

FIG. 4 depicts a front view of the ankle brace of FIG. 3.

FIG. 5 depicts a front view of a disassembled ankle brace of FIG. 3.

FIG. 6 depicts a cut away view of the brace of FIG. 3.

FIG. 7 depicts an arrangement of inflatable fluid bladders on a person's limb.

FIGS. 8A and 8B depict three-dimensional and side views, respectively, of an inflatable bladder assembly.

FIGS. 9A and 9B depict a partially overlapping configuration of a plurality of inflatable bladders.

FIGS. 10A and 10B depict an encapsulated configuration of a plurality of inflatable bladders.

FIGS. 11A and 11B depict a partially overlapping configuration of a plurality of inflatable bladders.

FIGS. 12A and 12B depict a stacked configuration of a plurality of inflatable bladders.

FIG. 13 depicts an embodiment of a brace designed to be applied to a person's knee.

FIGS. 14 and 15 depict a brace connected to a fluid source.

FIG. 16 depicts a brace as applied to a person's elbow.

### DETAILED DESCRIPTION OF CERTAIN ILLUSTRATED EMBODIMENTS

The systems and methods described herein will now be described with reference to certain illustrative embodiments. However, the invention is not to be limited to these illustrated embodiments which are provided merely for the purpose of describing the systems and methods of the invention and are not to be understood as limiting in anyway.

As will be seen from the following description, the systems and methods described herein, include, among other things, orthopedic appliances and methods of applying therapy to the limb of a patient for the purpose of reducing edema. In one aspect, the systems include a therapy system that may be fitted over a patient's limb about a joint for the purposes of treating limb injury by reducing or milking edema. In other aspects, the systems and methods may be adapted to provide intermittent massaging of lymph fluid through the lymphatic vessels in a direction toward the heart, which is toward the center of a patient's torso and away from the patient's affected limb.

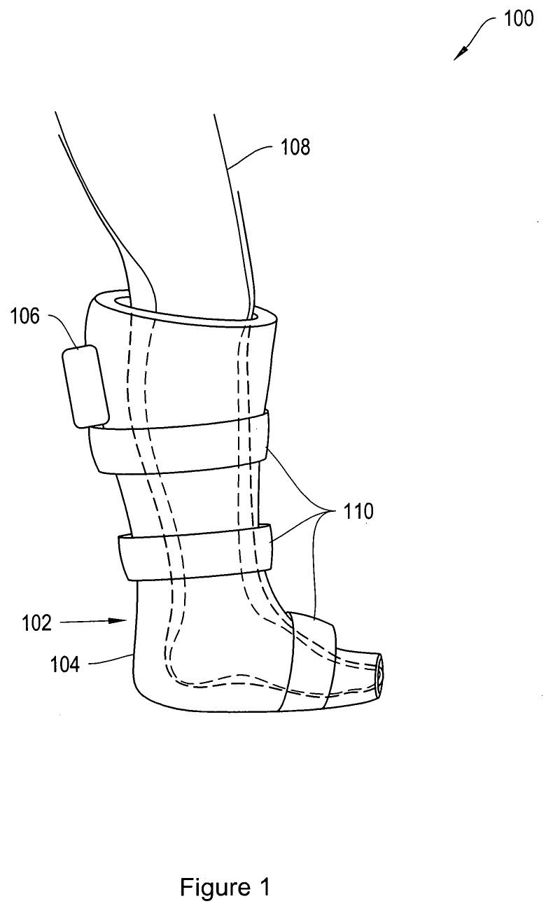

FIG. 1 depicts a therapy system 100 worn by a patient, according to an illustrative embodiment of the invention. More particularly, the therapy system 100 includes a brace 102 having an outer shell 104 and a pump system 106 attached to the outside of the outer shell 104. The brace 102 includes a plurality of inflatable fluid bladders located internally within the outer shell 104. The brace 102 also includes straps 110 for tightening and/or loosening the fit of the brace on the user's leg. The straps 110 are located near the upper calf, lower calf and around the foot. The therapy system 100 includes a pump 106 for supplying a fluid (for e.g., air) to the internal inflatable fluid bladders. The pump 106 is attached to the back portion of the outer shell 104 in the upper calf region and is in fluid communication with one or more of the plurality of inflatable fluid bladders. During operation, the pump 106 sequentially inflates and deflates one or more of the plurality of inflatable fluid bladders within the brace 102 to provide compression therapy. However, in alternative embodiments the brace 102 and pump 106 may, together or individually, be of the type that is applied to a limb while the person is remaining off his/her feet, on crutches or remaining on bed rest. In the embodiment depicted in FIG. 1, the brace 102 is a walking brace of a type that may be worn by a person in a manner that allows the person to remain ambulatory during treatment. The brace 102 extends from the front of the foot near the person's toes up to the upper calf, near the bottom of the knee.

In certain embodiments, the outer shell 104 is constructed of any suitable rigid material such as plastics, metals or combinations thereof to provide support to the limb while ambulating. The outer shell 104 may be formed from a plurality of separate rigid parts that may be assembled together to form the brace 102. In such embodiments, a person may detach the separate rigid parts of the outer shell 104, slide a limb into the brace 102 and then re-attach the separate rigid parts to secure the brace 102. The person may optionally adjust the straps 110 to tighten or loosen the fit. In other embodiments, the outer shell 104 is formed as a unitary body that is sized and shaped as desired to fit a person's limb. As an example, the outer shell 104 is sized and shaped like a boot to fit a person's leg. In such embodiments, rigid materials are cast in a permanently continuous manner such that at least one of the inner and outer surface of the outer shell 104 is substantially seamless. The rigid outer shell 104 may be formed in other ways without departing from the scope of the invention.

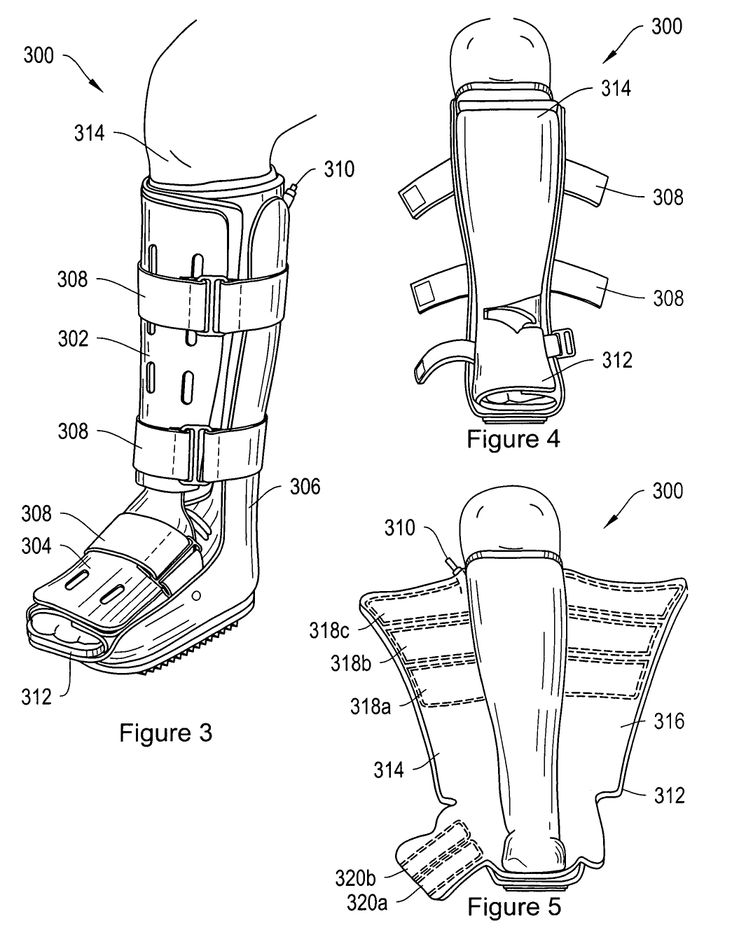

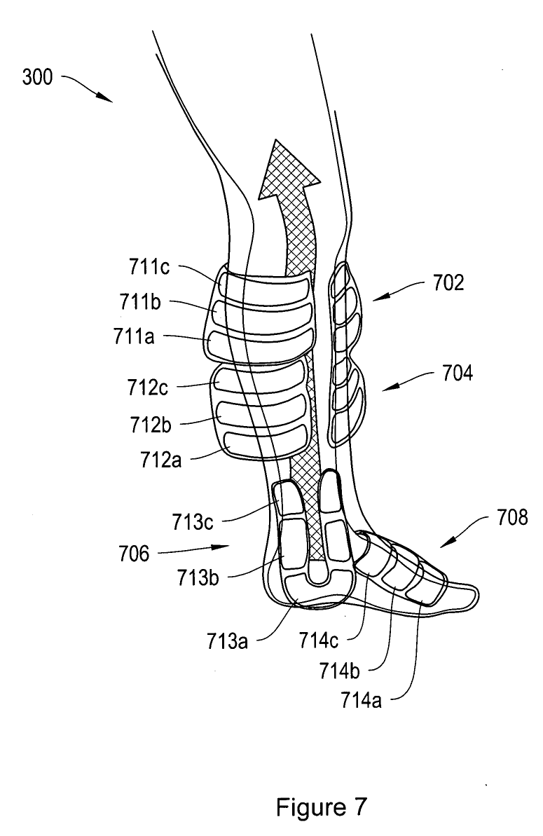

In certain embodiments, the internal inflatable fluid bladders are made of any suitable gas, liquid or gel impermeable material, such as urethane, PVC films, treated nylon, and/or laminates. One or more inflatable fluid bladders may be attached to an inner surface of the outer shell 104 along the length of the brace 102. One embodiment of the brace along with the inflatable fluid bladders is depicted in FIGS. 3-6. Other embodiments of the inflatable fluid bladders are described in more detail later with reference to FIGS. 7-12. One or more of the inflatable fluid bladders may be connected to the pump 106 through a fluid conduit or tube.

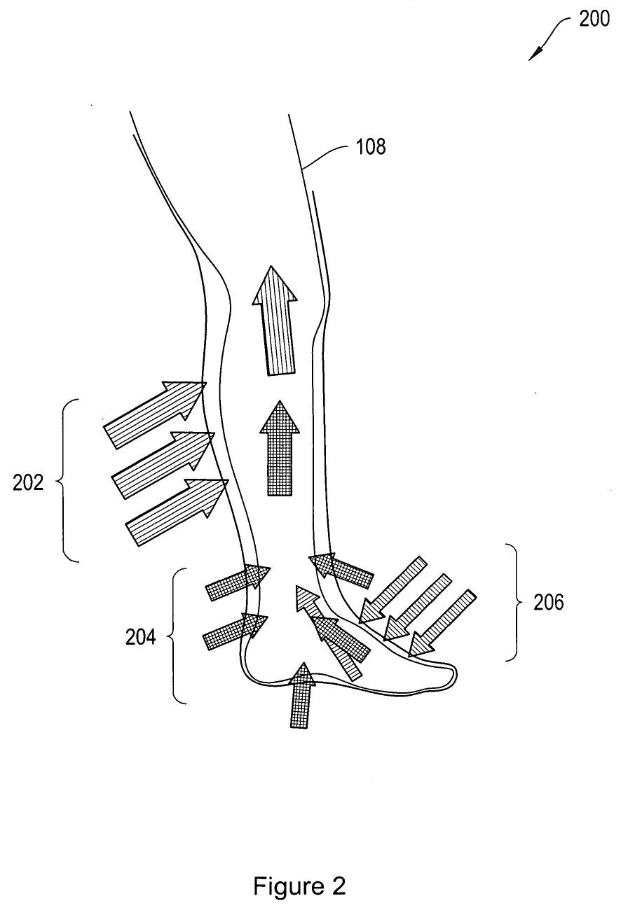

The pump 106 may be any pump mechanism capable of inflating and optionally deflating the inflatable bladders, to apply pressure to the person's limb. In certain embodiments, the pump 106 is adapted to operate the plurality of bladders to provide for a massage process that moves the edema away from the lower limb. In such embodiments, the pump 106 may be manually operated, or may be an automatic pump operated by a computer control system so that the bladders are sequentially inflated and deflated. The inflation/deflation sequence may follow a reversed sequence pressure application scheme for massaging a person's limb that is described, in more detail, with reference to FIG. 2.

FIG. 2 depicts a massage process 200 for incrementally massaging a user's limb 108 at different regions along the limb 108, according to an illustrative embodiment of the invention. More specifically, FIG. 2 depicts that the massaging process 200 takes place across a plurality of zones along a person's leg, in this case zones 202, 204 and 206, wherein zone 202 corresponds to the calf region of the leg, zone 204 corresponds to the ankle region, and zone 206 corresponds to the foot area. Each zone may be further conceptualized as having a plurality of anatomic regions. The anatomic regions of zone 202 may be the lower calf area, the mid-calf area, and the upper calf area. The anatomic regions of zone 204 may be the heel region, the ankle region in the area of the maleolus, and the Achilles area. The anatomic regions of zone 206 may be the distal metatarsal area, the navicular region, the region proximal to the navicular region and distal to the maleolus region. The anatomic regions may be any desired portion of any limb without departing from the scope of the invention. In certain embodiments, one or more inflatable fluid bladders are disposed in each of the zones in the vicinity of one or more anatomic regions for applying pressure to the anatomic regions of the person's limb 108.

The configuration of bladders in the therapy system 100 allows for milking fluid away from the user's limb. More particularly, the zones and the bladders work in cooperation so that fluid is moved in a manner that pushes fluid first from a proximal part of the limb toward the user's torso, followed by milking the next more distal part of the limb to the already volume-reduced proximal part (e.g., zone 202 first, followed by zone 204, etc.).

In operation, the therapy system 100 depicted in FIG. 1, when applied to the leg, activates bladders positioned in contact with the zones and regions shown in FIG. 2. In a first step, the therapy system 100, including an assembly of inflation bladders, is positioned on the leg and is activated via pump 106 to selectively inflate various bladders of the brace 102 to move fluid upward through the leg. In the depicted embodiment, the pump 106 first inflates a portion of the brace 102 adjacent to zone 202, moving fluid away from the anatomic regions of zone 202. In a second step, zone 204 is activated as pump 106 inflates a portion of the brace 102 in zone 204 to move fluid away from the ankle area by moving fluid away from the anatomic regions in zone 204 and up to the mid and upper calf areas of zone 202 of the patient's leg. In a subsequent step, the pump 106 inflates a portion of the brace 102 in zone 206 by moving fluid away from the anatomic regions in Zone 206 to move fluid away from the foot area into the mid-ankle section of zone 204. Accordingly, the brace 102 depicted in FIG. 1 performs a process that begins by moving edema that is located proximately to the user's torso, and subsequently moving fluid from sections of the limb that are more distal. The massage process 200 may be implemented by inflating and deflating a plurality of inflatable fluid bladders that are arranged in particular configurations along the length of limb. Inflating and deflating the bladders in a desired pattern compresses particular anatomical regions of the limb and thereby pushes the edema in a desired direction, either distally or preferably proximally, and particularly across a joint. The inflatable fluid bladders may be configured in any number of arrangements in the brace without departing from the scope of the invention.

FIGS. 3, 4, 5 and 6 depict more detailed views of an ankle brace 300, according to an illustrative embodiment of the invention. More particularly, FIG. 3 depicts a view of a fastened ankle brace 300 as applied to a person's limb. The brace 300 has a rigid outer shell 302, including a front shell portion 304, a rear shell portion 306, an interior resilient foam liner 312 and a plurality of inflatable fluid bladders 318a, 318b, 318c, 320a and 320b (referred to hereinafter as “bladders 318” or “bladder 320” or “bladders 318 and 320”) disposed within the foam liner 312. The foam liner 312 may include a lateral foam liner portion 316 and a medial foam liner portion 314. The front shell portion 304 and rear shell portion 306 protect and support the injured leg while the foam liners portions 314 and 316 and/or the inflatable fluid bladders 318a-318c and 320a-320b cushion the leg against the shell portions 304, 306 and provide therapy to a leg to speed healing and provide greater comfort. The brace 300 also includes one or more straps 308 connected to at least one of the outer shell 302, the foam liner 312 and the bladders 318 and 320 for fastening and thereby securing the brace 300 onto a person's limb. The straps may include flexible strips of material with hook and loop type fastening means such as VELCRO™.

FIG. 4 depicts the ankle brace 300 as applied to a limb where the straps 308 have been unfastened and the front shell portion 304 has been removed. In particular, FIG. 4 depicts the foam liner 312 wrapped around the person's limb such that the medial foam liner portion 314 overlaps at least a portion of the lateral foam liner portion 316. FIG. 5 depicts the ankle brace 300 as applied to a limb where the foam liner 312 has been unwrapped to reveal the person's limb. The brace 300 additionally includes bladders 318 and 320 arranged in the vicinity of desired anatomic regions of the person's limb. Inflatable fluid bladders 318a, 318b and 318c are arranged along a substantial portion of a person's upper-calf region and mid-calf region. Inflatable fluid bladders 320a and 320b are arranged along a portion of a person's distal metatarsal region and navicular region. The bladders 318 and 320 are located within the foam liner 312. The bladders 318 and 320 may be arranged in the vicinity of any anatomic region of a person's limb without departing from the scope of the invention.

The inflatable fluid bladders may be constructed of two sheets of flexible plastic sealed around their perimeter to make a gas impermeable packet. In certain optional embodiments, the bladders 318 and 320 may be formed from a single sheet of flexible plastic material folded over onto itself and sealed along the open edge. In such embodiments, the bladders 318 and 320 are formed and sealed in a single step. The bladders 318 and 320 may be sealed by RF heat sealing or standard heatsealing techniques. In certain embodiments, Polyvinyl chloride films and polyurethane films are suitable for use in the inflatable fluid bladders. In certain optional embodiments, the bladders 318 and 320 include a layer of foam, including open cell or closed cell foam disposed therein. The layer of foam may be larger than the typical space between the patient's ankle and corresponding shell portion of the outer shell when the foam is in its fully expanded state.

In certain optional embodiments, one or more bladders 318 and 320 are disposed on the inner surface of the foam liner 312 such that they are closer to the person's limb than the foam liner 312 and outer shell 302. In such embodiments, a layer of fabric is attached to the one or more of the bladders 318 and 320. The layer of fabric may be selected based, at least in part, on its tactile and/or ventilation and/or therapeutic and/or washability properties. The layer of fabric may include a proportion of Nylon to facilitate bonding to one or more bladders 318 and 320.

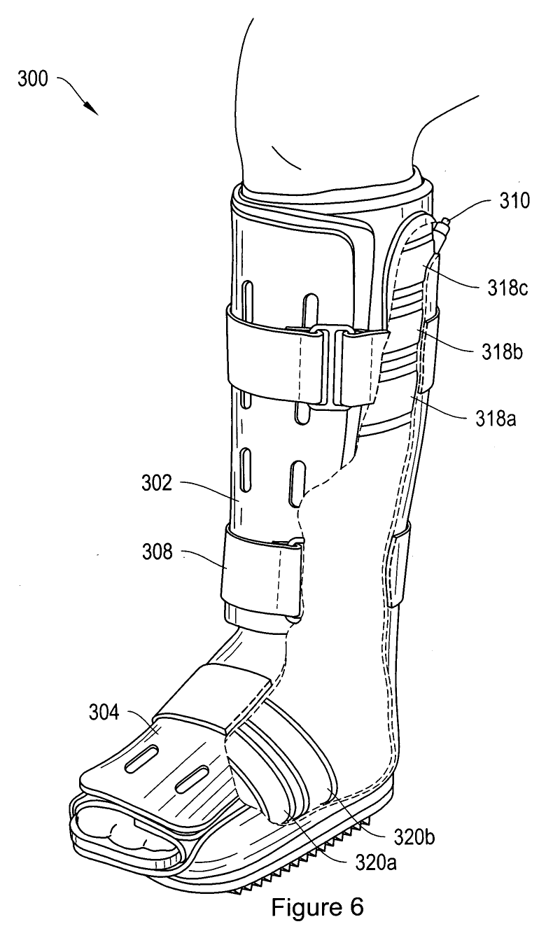

Referring to FIGS. 5 and 6, one or more bladders 318 and 320 have a conduit 310 extending from the bladders 318 and 320 to the exterior of the outer shell 302. The conduit 310 links the interior of one or more of the inflatable fluid bladders 318 and 320 with the atmosphere and/or the pump 106. The conduit 310 may be made of flexible plastic tubing. The conduit 310 may terminate a fluid port provided with a closable sealing mechanism to trap air in the bladder and maintain the bladder at a constant volume. The sealing mechanism may comprise, for example, a hinged stopper or a rotatable valve.

FIG. 7 depicts a plurality of bladder assemblies, each having a plurality of inflatable fluid bladders, as applied to a person's leg, according to an illustrative embodiment of the invention. In particular, FIG. 7 depicts four bladder assemblies 702, 704, 706 and 708 having inflatable fluid bladders that are similar to bladders 318 and 320 and may be attached to the interior of the brace 102 of FIG. 1 and brace 300 of FIGS. 3-6. In the depicted embodiment of FIG. 7, each of the four bladder assemblies 702, 704, 706 and 708 includes three bladders and are positioned near one of four zones covering different anatomic regions of a person's leg. In certain embodiments, bladder assemblies 702 and 704 are each located on the proximal side of the ankle and the bladder assembly 708 is located on the distal side of the ankle. Portions of the bladder assembly 706 are located on both proximal and distal sides of the ankle. Bladder assembly 702 is positioned near the upper calf region and includes inflatable fluid bladders 711a, 711b and 711c, arranged in a distal to proximal direction. Bladder assembly 704 is positioned near the mid-calf and lower-calf region and includes inflatable fluid bladders 712a, 712b and 712c, arranged in a distal to proximal direction. Bladder assembly 706 is positioned near the heel and ankle region and includes inflatable fluid bladders 713a, 713b and 713c, arranged in a distal to proximal direction. Bladder assembly 706 typically comprises a stirrup and fits under the patient's sole. Bladder assembly 708 is positioned near the foot region and includes inflatable fluid bladders 714a, 714b and 714c arranged in a distal to proximal direction.

During operation, the pump 106 inflates one or more inflatable bladders in distal portion of proximal bladder assemblies 702, 704 and 706 then inflates one or more inflatable bladders in a proximal portion of proximal bladder assemblies 702, 704 and 706. Similarly, during operation, the pump 106 inflates one or more inflatable bladders in a distal portion of distal bladder assemblies 706 and 708 then inflates one or more inflatable bladders in a proximal portion distal bladder assemblies 706 and 708. The bladders are sequentially activated so that in each bladder assembly, the bladder most distal is activated first, and the other bladders are subsequently activated such that fluid is moved from the distal most portion of the zone in a proximal direction away from the zone. Bladder assembly 708 may be positioned on top of and adjacent to the upper part of the person's foot providing pressure from the most distal section of the person's leg. In certain embodiments of the four-zone system, an exemplary sequence of inflation begins by inflating bladder 711a in bladder assembly 702 and concludes by inflating bladder 714c in bladder assembly 708 as follows:
Inflate: bladder 711a, followed by bladder 711b, followed by bladder 711c, and then
   bladder 712a, followed by bladder 712b, followed by bladder 712c, and then
   bladder 713a, followed by bladder 713b, followed by bladder 713c, and then
   bladder 714a, followed by bladder 714b, and followed by bladder 714c, and then restart the cycle, as desired.

In certain embodiments, the methods comprise repeating the step of inflating one or more bladders and thereby applying compression to the limb until a desired target level is reached. The target level may include at least one of a number of cycles of compression, a time limit, a user-selected stopping point and a therapist selected stopping point. Other suitable target levels may be used without departing from the scope of the invention.

A series of deflation steps may also be included to allow the brace to optimally move fluid away from the affected limb. To this end the brace is adapted to sequentially deflate the bladders within the zones to optimize the flow of fluid away from the limb. The deflation sequences are programmed to deflate a zone at or near the same time the zone just distal begins to inflate. For example, bladder 702 begins to deflate as bladder 704 begins to fill, such that the fluid pressure decreases in bladder 702 to receive the fluid flowing from bladder 704 as a result of the filling and pressurizing of bladder 704. In an exemplary implementation, the inflation sequence identified above would include deflation steps as follows:
Deflate: bladders 711a, 711b and 711c simultaneous with inflation of bladder 712b,
Deflate: bladders 712a, 712band 712c simultaneous with inflation of bladder 713b,
Deflate: bladders 713a, 713b and 713c simultaneous with inflation of bladder 714b, and
Deflate: bladders 714a, 714b and 714c after maintaining such bladders in an inflated state for a desired time period.

In certain embodiments, one or more of the bladders in the proximal bladder assemblies 702, 704 and 706 are deflated after inflation, and while inflating one or more of the bladders in the distal bladder assemblies 706 and 708. In alternative embodiments, one or more of the bladders in the proximal bladder assemblies 702, 704 and 706 are deflated after inflating one or more of the bladders in the distal bladder assemblies 706 and 708. One or more of the bladders in the distal bladder assemblies 706 and 708 may be deflated after inflation. In certain embodiments, one or more of the bladders in the proximal bladder assemblies 702, 704 and 706 are deflated after deflating one or more of the bladders in the distal bladder assemblies 706 and 708. In certain embodiments, deflating the proximal bladder assembly 702, 704 and 706 and/or the distal bladder assemblies 706 and 708 includes simultaneously deflating substantially all of the plurality of inflatable bladders. The bladders in the bladder assemblies 702, 704, 706 and 708 may be inflated and/or deflated in any sequence so as to move edema towards the user's torso.

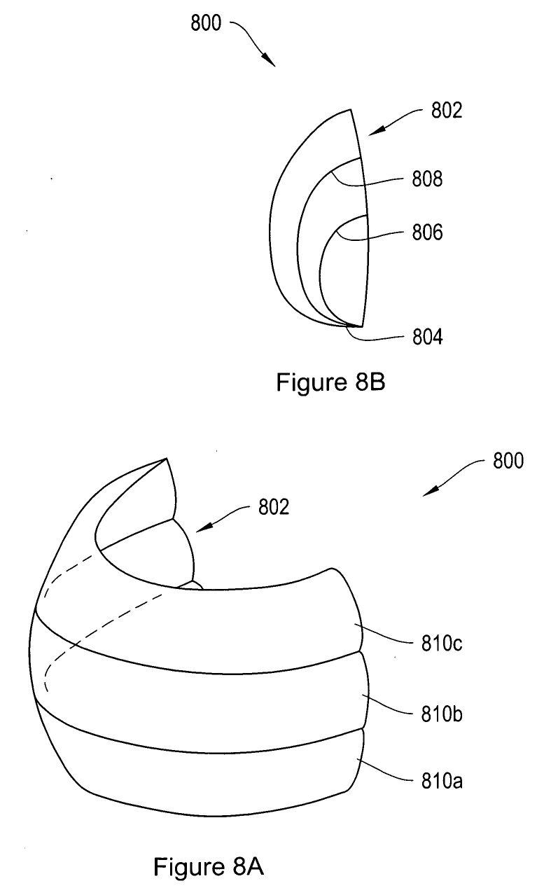

In one aspect, the bladders, such as the bladders used with the brace shown in FIG. 1, are configured to form a bladder set or a bladder assembly. More particularly, FIGS. 8A and 8B depict cross-section and right-side perspective views of an overlapping/encapsulated bladder assembly 800 for use with the brace 102 and/or 300. As shown, the assembly 800 includes three bladders—810a, 810b, and 810c that adjoin along an inner membrane layer 802 and a common distal seam 804. The bladders form an encapsulating assembly, wherein bladder 810a is the smallest of the bladders and is encapsulated by larger bladder 810b along membrane layer 806. Bladder 810b extends beyond the perimeter of bladder 810a and into a region along the limb that is proximal to bladder 810a. Bladder 810b, with bladder 810a inside, is encapsulated by bladder 810c, which is the largest bladder, along membrane layer 808. Bladder 810c extends beyond the perimeter of bladder 810b into a region proximal to bladder 810b. In operation, when bladder 810a is inflated, it applies pressure to the limb at a position coextensive with the perimeter of contact between the limb and bladder 810a. This causes fluid to flow away from bladder 810a. When bladder 810b is inflated, it applies additional pressure to the limb beyond the perimeter of bladder 810a along the region covered by bladder 810b, thereby pushing the fluid leaving the bladder 810a region further toward the torso. When bladder 810c inflates, it applies pressure to the limb beyond the perimeter of bladder 810b, thereby pushing fluid within its perimeter of contact toward the heart.

In one exemplary implementation, the bladders 810a-c of FIGS. 8A-8B are inflated in a distal-first, proximal-next pattern. This pattern begins with the inflation of bladder 810a, which is the distal-most bladder in the assembly 800. The inflation of bladder 810a compresses the limb and pushes fluid away from the region covered by bladder 810a, and up the user's limb toward the torso, into the region covered by bladder 810b. The inflation of bladder 810a is followed by the inflation of bladder 810b, which compresses the limb in the region covered by bladder 810b, thereby pushing fluid received from bladder 810a along with other fluid in the region of bladder 810b further up the limb and into the region covered by bladder 810c. Bladder 810c then inflates, which compresses the limb in the region covered by bladder 810c and pushes the fluid received from the inflation of bladder 810b (in the previous step) along with other fluid in the region of bladder 810c up the limb and further toward the torso. The inflation pattern using this assembly of encapsulated inflatable bladders helps move fluid away from the injury site and toward the torso.

A plurality of bladder assemblies, such as assembly 800, can be configured in an inflation system, with a separate bladder assembly being positioned along the limb in operational contact with one or more anatomical regions corresponding to zones near bladder assemblies 702, 704, 706 and 708 of FIG. 7. In one exemplary application of a system of this type, the proximal zone assembly is inflated first (inflating the most distal bladder 810a first, then bladder 810b, and followed by bladder 810c which is the most proximal bladder within the proximal zone), followed by the next most distal zone assembly (in the same 810a-c pattern), and so on until the most distal zone assembly is inflated.

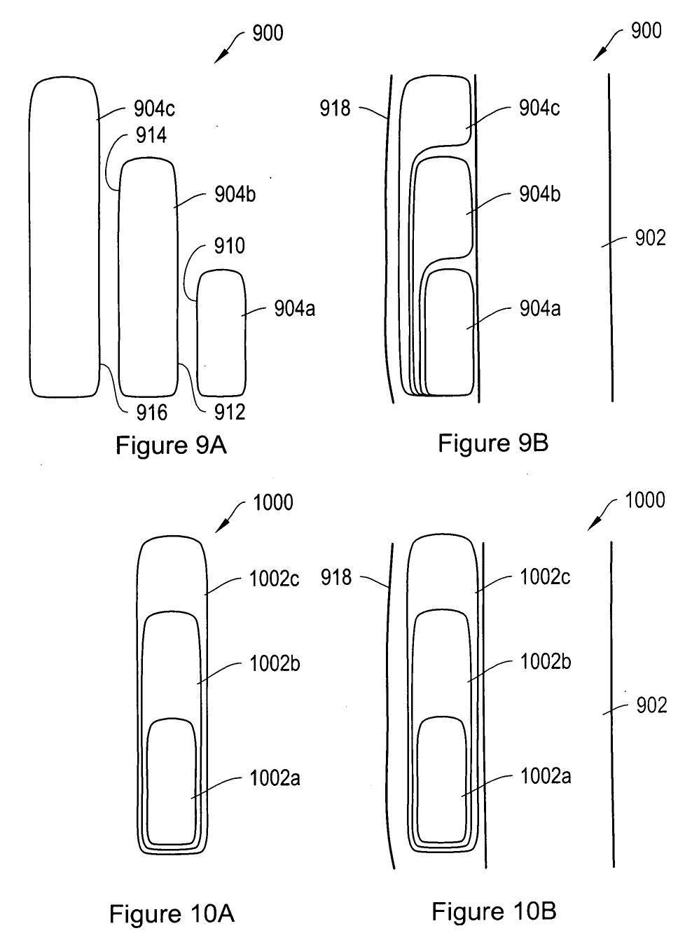

The encapsulated configuration shown in FIGS. 8A and 8B, a bladder assembly 800 can be formed of a variety of different configurations, such as, for example, stacked, partially overlapping or fully overlapping configuration. FIGS. 9A through 12B depict various alternative configurations of inflation systems. FIGS. 9A and 9B depict an exemplary inflation system 900 that is configured with three inflation bladders interoperationally arranged to apply inflation and deflation to a user's limb 902. More particularly, the assembly 900 includes bladders 904a, 904b and 904c with bladder 904a and bladder 904b joined (either fixed or reversibly connected) along a seam 906. The seam 906 is formed by joining edge 910 of bladder 904a along edge 912 of bladder 904b. Bladder 904b joins with bladder 906c along a seam 908 as edge 914 of bladder 904b is joined to edge 916 of bladder 904c. Each of the seams 906 and 908 may be configured to allow the respective bladders to interfit directly (e.g., by gluing, zipping or stitching) or to be interoperationally connected (e.g., by applying contoured shaping to the bladder). Once formed, the assembly of bladders 904a through 904c is then disposed within a rigid shell 918 to form the bladder assembly 900 for use with the user's limb 902. A plurality of the assembly 900 can also be used, and each member may have a plurality of bladders placed at a particular locale along a patient's limb.

FIGS. 10A and 10B depict an exemplary alternative configuration of a bladder assembly 1000 used as an inflation assembly for applying pressure for inflating and deflating therapy to a user's limb 902. As shown in FIGS. 10A-10B, inflation bladder 1002a is disposed within bladder 1002b, and bladder 1002bis disposed within bladder 1002c, forming an encapsulated system that is then disposed within the housing 918 to form the inflation system 1000.

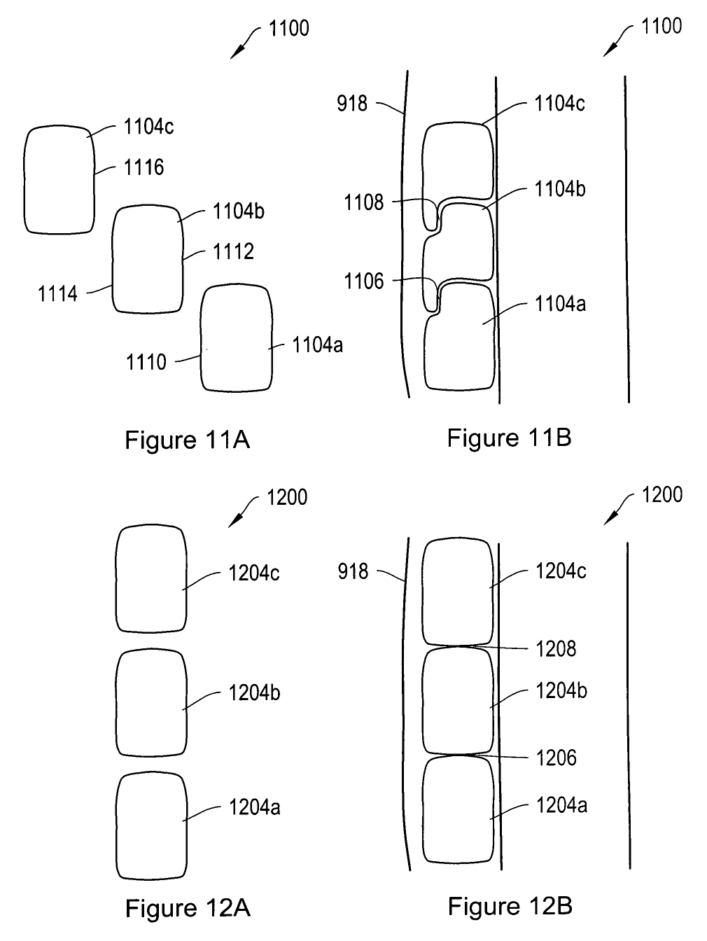

FIGS. 11A and 11B depict another exemplary embodiment of an inflation system 1100, similar to the inflation systems described previously, with bladders 1104a, 1104b and 1104c configured in a slightly overlapping fashion. In particular, bladder 1104b is pressed against bladder 1104a such that edge 1112 of bladder 1104b is pressed against edge 1110 bladder 1104a to form a seam 1106 (which may be fixed or reversibly connected together, such as through the use of stitching, VELCRO™, adhesive, zipper, or any other mechanism for adjoining the two regions 1110 and 1112 together). Similarly, region 1114 of bladder 1104b is pressed against region 1116 of bladder 1104c, such that seam 1108 forms between the two bladders. The bladders 1104a-c are then disposed within the housing 918 and optionally within the housing 1118 on the limb side of the patient, thereby forming the assembly 1100 for use to apply compression and decompression to the patient's limb 902.

FIGS. 12A and 12B depict yet another alternative configuration of an inflation system 1200, similar to the inflation systems described above, except that bladders 1204a, 1204b and 1204c are formed in a stacked configuration, with seam 1208 formed between bladders 1204B and 1204c, and seam 1206 formed between bladders 1204a and 1204b. The stacked configuration of bladders 1204a-c are disposed within the housing 918, thus forming the inflation assembly 900, which may be applied to the user's limb 902.

In exemplary methods of operation, the bladders of the assemblies 800, 900, 1000, 1100 and/or 1200 may be inflated and/or deflated at selected cycles to cause the movement of fluid away from the limb and toward the torso, in the direction of arrow 920. In one such implementation, in a first step, bladder “a” (810a, 902a, 1002a, 1104a, or 1204a) is inflated, which compresses the limb in the region covered by bladder “a” and pushes fluid in that region away from the region. In a second step, bladder “b” (810b, 902b, 1002b, 1104b, or 1204b) is inflated and bladder “a” is optionally deflated. In this step, bladder “b” compresses the region under bladder “b” to push the fluid received from the compression of bladder “a” toward the torso and to hinder the fluid that was pushed during the first step from flowing back into the region of bladder “a.” In a third step, bladder “c” (810c, 902c, 1002c, 1104c, or 1204c) is inflated and bladder “b” is optionally deflated, further pushing the fluid toward the torso and impeding the fluid from flowing back into the region covered by bladder “a” and bladder “b.”

The exemplary assemblies 900, 1000, 1100 and 1200 are described above as being applied to a particular zone of the user's limb. In alternative implementations, an inflation system is provided that includes plurality of inflation assemblies similar to those described, with each individual inflation assembly being configured to be applied at a different anatomical zone along the limb, such as the zones shown in FIG. 7. An exemplary multi-zone inflation system may include a proximal assembly applied to a proximal portion of the limb, a distal assembly applied to a distal portion of the limb and one or more mid-limb assemblies applied to one or more mid-regions of the limb. In one exemplary mode of operation, the proximal assembly of such a system is inflated first, beginning with inflation of bladder “a”, followed by the inflation of bladder “b” and deflation of bladder “a”, and followed by the inflation of bladder “c” and deflation of bladder “b”. Next, the one or more mid-region assemblies is activated and inflates/deflates in a similar bladder “a”—bladder “c” pattern. Finally, the distal region is activated and inflated/deflated in the bladder “a”—bladder “c” pattern.

As noted above, the inflation systems may be configured to provide compression and decompression massage to the regions of one or more limbs of a patient to provide enhanced circulation and for causing fluid to flow toward the patient's torso. In certain representative embodiments, the compression pressures that may be selected for upper and/or lower pressure limits, as applicable, may be selected from those set forth in U.S. Utility application Ser. No. 10/389,449 (Berish, et al.), the entire contents of which is incorporated herein by reference in its entirety. Other exemplary pressure levels and other applications are those set forth in U.S. Pat. No. 6,463,934, U.S. Pat. No. 6,592,534, and U.S. Pat. No. 5,588,955, the entire contents of each of which are incorporated herein by reference in their entirety. In certain exemplary implementations, the pressure applied by inflating any particular inflation cell used with an inflation assembly is between about 20 to about 50 mm Hg. In certain exemplary applications, the pressure applied during inflation of an inflation cell is greater than about 50 mm Hg, even greater than about 70 mm Hg, or even greater than about 100 mm Hg. In certain applications, the pressure of an inflation cell is less than about 50 mm Hg, or even less than about 30 mm Hg, or even less than about 20 mm Hg.

In certain applications, the inflation systems described above include one or more pumps that may be assembled with the inflation assembly (such as through a direct fixation of the pump with the inflation system) or may be housed separately and connected to the inflation system through one or more tubes or other conduits. In certain applications, a particular inflation assembly is provided with a plurality of pumps, with each pump provided in a manner that is configured to independently inflate and deflate its respective particular cell within the inflation system. In certain embodiments, the inflation assembly is provided with a separate pump independently operable for inflating each inflation cell within the inflation system. By providing for a separate and independent inflation of any particular cell within the system, the inflation assembly is configured to provide variable pressures within each region, within each zone, or within any combination thereof. In certain exemplary applications, the patient and/or the attendant healthcare provider can inflate any particular cell at any particular time to any desired level of pressurization.

In other embodiments, the cycles of this inflation and deflation of the cells can also be established through the independent inflation and deflation of the particular cells within the inflation assembly. Moreover, the patient and/or the healthcare provider can provide variable levels of pressure within each particular inflation region within each particular zone in the inflation system. In another implementation, the pressure levels within a particular cell could be pre-set to a particular desired level, which could vary from one cell to another within a particular inflation assembly, and the inflation system configured to inflate and/or deflate each particular cell as desired to achieve a particular inflation and deflation sequence.

As noted, one or more pumps may be applied to inflate and deflate the bladders used in the particular inflation systems described herein. Each of the bladders described and shown in the Figures or otherwise implicated by this disclosure can be configured to receive a pump through a conduit tube or other mechanism whereby the bladder is configured with an inflation port to receive a tube from a pump or other inflation source. As noted, each bladder used in a particular inflation assembly may be separately configured to receive a pump through an interface, or the bladders may be configured to be inflatable and deflatable through a single inflation port that runs through each of them and connects to a single inflation source. As multiple inflation ports and assemblies are used, one or more pumps may be used to inflate and deflate the bladders, and the inflation may be configured through the use of a single or multiple inflation ports adapted to connect to one or more inflation sources.

The above described applications are representative of exemplary embodiments of the systems and methods described herein and are not to be understood as limiting in any way. The embodiments depicted in the figures are shown as applying to treatment of edema in a patient's lower leg; however, the invention may be readily adapted for use in treating edema in any extremity of a patient (e.g., patient's foot, lower leg, upper leg, arm, wrist, thigh, hand or finger). The embodiments described above could be adapted to provide an inflation assembly to any number of anatomical zones along a limb, and optionally configured to provide inflation bladders for operation upon any number of regions within each particular zone. For example, an inflation assembly may be provided that provides a plurality of inflation bladders in a region adjacent to an upper limb, and another plurality of bladders applied to a region adjacent to a lower zone on a limb. In certain exemplary configurations, an inflation system is provided with a plurality of inflation bladders arranged in a plurality of bladder series, with one or more series applied to one limb while one or more other series is applied to a second or other limb more limbs. In certain exemplary configurations, an inflation assembly is provided that includes inflation bladders for application to at least two or more anatomical zones along a limb, and such that each zone has one or more inflation bladders applied to one or more particular regions within each zone. Other adaptations, modifications and supplements to the systems and methods described herein may also be employed without department from the scope of the invention and such adaptations, modifications and supplements will be understood to fall within the scope of the invention.

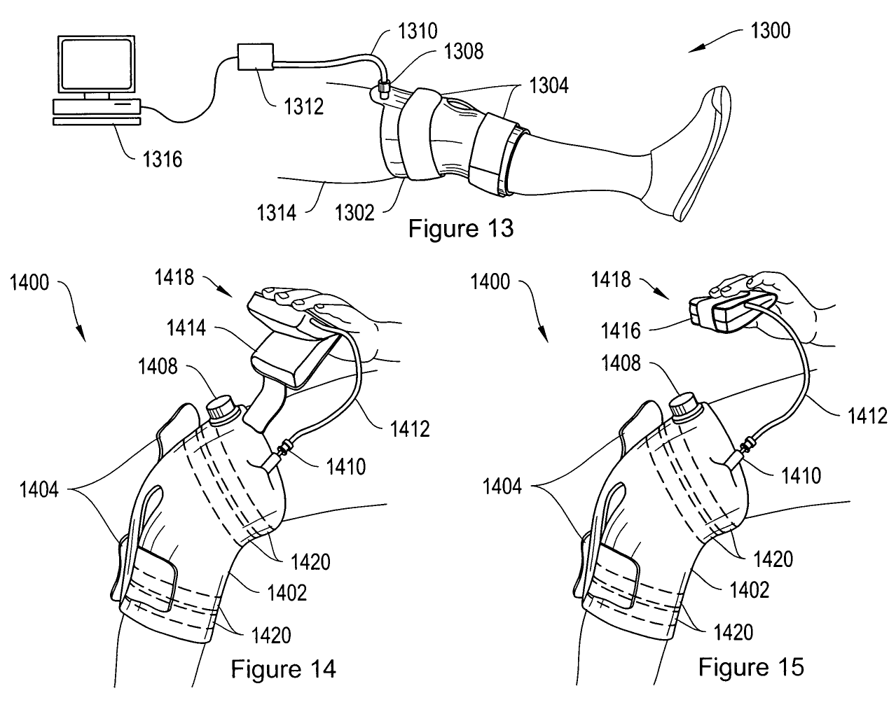

In certain adaptations, an inflation bladder assembly such as those described above are configured for use in a computer-controlled bracing system. FIG. 13 depicts one prototype embodiment of a bracing system 1300 having a brace designed to be applied to the knee of the leg 1314 of an individual. The brace of system 1300 has inflatable fluid bladders that are inflated and deflated with air through a pump 1312. The brace in system 1300 is similar to braces 100 and 300. The brace includes a shell 1302, straps 1304, support system 1306, fluid port 1308 and internal inflatable fluid bladders. The fluid port 1308 is connected to the pump 1312 by tubing 1310. As shown, the pump 1312 is electrically connected to a computer based pump control system 1316 for operating the pump 1312. During operation, a sequence of pressurize and depressurize commands are sent from the computer 1316 to the pump 1312. The commands may be previously programmed in the computer's 1316 hardware and/or software. Optionally, the commands may be entered in real-time by a person such as a patient or a health care provider.

In one embodiment, during operation, the brace of system 1300 is applied to the limb and the pump 1312 supplies or removes air to and from the inflatable fluid bladders within the brace. The flow of air is modulated through a software based system. Alternatively, a manually operated valve may be connected along the length of the tubing 1310 to control the flow of air and allow the flow to be stopped when a desired pressure is reached by manually closing the valve.

During operation, the circulation of fluid in the brace causes the expansion and contraction of the inflatable fluid bladders. The rigid support system 1306 helps maintain the structural integrity of the brace of system 1300 during the expansion and contraction of the inflatable fluid bladders.

The massage process described herein for controlling a pump may be programmed and executed on a conventional data processing platform such as an IBM PC-compatible computer running the Windows operating systems, a SUN workstation running a UNIX operating system or another equivalent personal computer or workstation. Alternatively, the data processing system may comprise a dedicated processing system that includes an embedded programmable data processing unit. For example, the data processing system may comprise a single board computer system that has been integrated into a system for performing micro-array analysis.

The massage process described herein for controlling a pump may also be realized as a software component operating on a conventional data processing system such as a UNIX workstation. In such an embodiment, the process may be implemented as a computer program written in any of several languages well-known to those of ordinary skill in the art, such as (but not limited to) C, C++, FORTRAN, Java or BASIC. The process may also be executed on commonly available clusters of processors, such as Western Scientific Linux clusters, which are able to allow parallel execution of all or some of the steps in the present process.

As noted above, the order in which the steps of the present method are performed is purely illustrative in nature. The steps can be performed in any order or in parallel, unless otherwise indicated by the present disclosure.

The method of the present invention may be performed in either hardware, software, or any combination thereof, as those terms are currently known in the art. In particular, the present method may be carried out by software, firmware, or microcode operating on a computer or computers of any type. Additionally, software for performing the systems and methods may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the systems are not limited to any particular platform, unless specifically stated otherwise in the present disclosure.

The computer terminal may include any computer system having a microprocessor, a memory and a microcontroller. The memory typically includes a main memory and a read only memory. The memory may also include mass storage components having, for example, various disk drives, tape drives, etc. The mass storage may include one or more magnetic disk or tape drives or optical disk drives, for storing data and instructions for use by the microprocessor. The memory may also include one or more drives for various portable media, such as a floppy disk, a compact disc read only memory (CD-ROM), or an integrated circuit non-volatile memory adapter ( i.e. PC-MCIA adapter) to input and output data and code to and from microprocessor. The memory may also include dynamic random access memory (DRAM) and high-speed cache memory.

Hardware components typically used to build the process module 106 may include programmable logic devices, programmable logic controllers, logic gates and flip flops or relays. Hardware implementation typically requires a register to store states, a block of combinational logic which determines the test conditions of transition rules, and a second block of combinational logic that determines the responses of transition rules. An FSM may be created and implemented using software tools including, but not limited to, the AT&T FSM Library™ provided by AT&T Labs, New Jersey, U.S.A. An FSM may also be created and implemented using software languages including, but not limited to, C, C++, JAVA, SCXML (State Chart XML). Interactive software modules may also be included in the computer that may assist users with pump control.

In certain embodiments, the pump is controlled by hand, such that a person may control the flow of air into the inflatable fluid bladders. FIGS. 14 and 15 depict a brace 1400 connected to a pump 1418, according to one illustrative embodiment of the invention. In particular, the brace 1400 is shown secured to a joint and includes a shell 1402, straps 1404 in an attached position, support system 1406 and a fluid port 1408. The fluid port 1408 is in fluid communication with the inflatable fluid bladder 1420. The fluid port 1408 is shown larger than fluid port 1308 of FIG. 13. The brace 1400 also includes a second fluid port 1410 in fluid communication with one or more of the inflatable fluid bladders 1420. The second fluid port is connected to a pump 1418 via tubing 1412. The pump 1418 is shown in an open position 1414 in FIG. 14 and in a closed position 1416 in FIG. 15.

During operation, the pump 1418 is shown to be hand squeezed to go from an open state 1414 in FIG. 14 to a folded state 1416 shown in FIG. 15. Squeezing the pump 1418 causes pressurized fluid such as air to pass through the tubing 1412 and second fluid port 1410 into the brace 1400. The pressurized fluid (air) enters the inflatable fluid bladder and applies pressure against a portion of the user's limb.

In one embodiment, the pump 1418 includes a rectangular body portion to which is attached a strap having a VELCRO™ strip thereon. The pump 1418 may be folded about its center and the VELCRO™ strap wrapped around the open end of the pump to have a mating contact with a second VELCRO™ strip on the obverse side of the pump. The pump 1418 may be formed from air impervious resilient material such as plastic. The pump may include layers of rigid material and/or layers of foam material. Other types of pumps may be used for supplying pressurized fluids without departing from the scope of the invention.

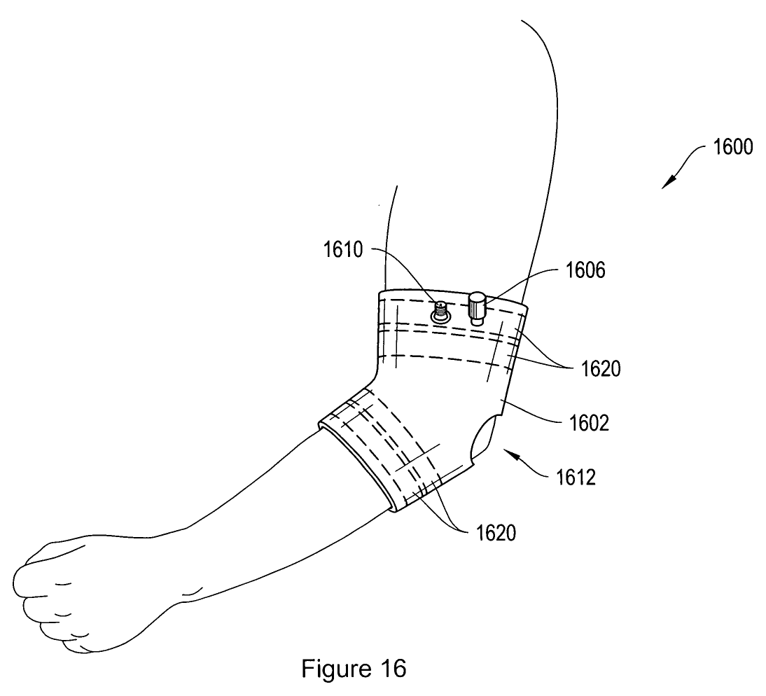

FIG. 16 depicts a temperature regulated compression brace 1600 as applied to a patient's elbow, according to an illustrative embodiment of the invention. The brace 1600 is similar to braces 100 and 300. Brace 1600 includes a shell 1602 having disposed thereon a fluid port 1606 and an air release valve 1610. The brace 1600 further includes an expandable inflatable fluid bladder in direct or indirect fluid communication with the fluid port 1606. The brace has a notch 1612 to accommodate the elbow joint.

In one embodiment, the brace 1600 is slid over the arm 1608 of an individual such that the notch is aligned with the elbow joint and the brace is snugly fit. An alternate embodiment for the elbow could be similar to brace 100 or 300 configured as a separate rigid brace. Fluid is introduced into the inflatable fluid bladders 1620 through the fluid port 1606. In certain embodiments, the temperature of the fluid is regulated at a particular value or range. For example, the fluid can be regulated to maintain a temperature below room temperature and close to freezing temperatures to provide cold therapy to the location of the joint. The fluid can also be regulated to maintain a temperature above room temperature and to provide heat therapy to the location of the joint. The fluid fills the inflatable fluid bladder and thereby causes it to expand. The expanding inflatable fluid bladder compresses the region of joint to stabilize the joint, while the temperature regulated fluid may also provide thermal therapy.

In certain optional embodiments, the brace includes a support system having rigid members and a hinge near a joint for controlling movement of the limb about the joint. The hinge may be lockable to prevent hyper-extension of the elbow. Prior to the application of the brace 1600 on the elbow, the hinge may be in an unlocked state such that the rigid members can pivot freely about the hinge. Once the brace 1600 is secured to the elbow, the hinge may be locked to allow the rigid members to pivot about the hinge within a certain desired range.

Those skilled in the art will know or be able to ascertain using no more than routine experimentation, many equivalents to the embodiments and practices described herein. Accordingly, it will be understood that the systems and methods are not to be limited to the embodiments disclosed herein, but are to be understood from the following claims, which are to be interpreted as broadly as allowed under the law. All references cited herein are expressly incorporated by reference in their entirety.

1. A brace for applying therapy to a limb, comprising:
a rigid outer shell, having an inner surface, adapted to be applied over proximal and distal sides of a limb about at least one joint, and
a proximal bladder assembly including a plurality of inflatable fluid bladders attached to the inner surface of the rigid outer shell on the proximal side of the limb, and
a distal bladder assembly including a plurality of inflatable fluid bladders attached to the inner surface of the rigid outer shell on the distal side of the limb.

2. The system of claim 1, wherein each of the plurality of inflatable fluid bladders in at least one of the proximal bladder assembly and the distal bladder assembly are positioned at least partially transverse to each other.

3. The system of claim 1, wherein each of the plurality of inflatable fluid bladders in at least one of the proximal bladder assembly and the distal bladder assembly are of different dimensions.

4. The system of claim 1, wherein each of the plurality of inflatable fluid bladders in at least one of the proximal bladder assembly and the distal bladder assembly are attached to each other using at least one of gluing, stitching and zipping.

5. The system of claim 1, wherein an inflatable fluid bladder in at least one of the proximal bladder assembly and the distal bladder assembly overlaps another inflatable fluid bladder in at least one of the proximal bladder assembly and the distal bladder assembly.

6. The system of claim 1, wherein an inflatable fluid bladder in at least one of the proximal bladder assembly and the distal bladder assembly is positioned inside another inflatable fluid bladder.

7. The system of claim 1, comprising at least one conduit in communication with at least one inflatable fluid bladder for providing fluid.

8. The system of claim 1, wherein one or more of the plurality of inflatable fluid bladders in at least one of the proximal and distal bladder assemblies substantially circumferentiates the limb.

9. The system of claim 1, wherein the rigid shell is adapted to be applied over the proximal and distal sides of a leg about a knee.

10. The system of claim 1, wherein the rigid shell is adapted to be applied over the proximal and distal sides of a leg about an ankle.

11. The system of claim 1, wherein the rigid shell is adapted to be applied over the proximal and distal sides of an arm about an elbow.

12. The system of claim 1, wherein at least one inflatable fluid bladder includes an inflation port for receiving a fluid conduit.

13. The system of claim 1, further comprising a fluid source for supplying fluid to at least one of the proximal and distal bladder assemblies.

14. The system of claim 13, wherein the fluid source includes at least one of a pump and a fluid reservoir.

15. The system of claim 1, comprising a plurality of proximal bladder assemblies.

16. The system of claim 1, comprising a plurality of distal bladder assemblies.

17. An inflatable bladder assembly for applying therapy to a limb, comprising:
a bladder assembly positioned in the vicinity of an anatomical region of a limb and configured to apply pressure to the anatomical region, including:
a first inflatable bladder,
a second inflatable bladder, positioned adjacent to the first inflatable bladder, and
a third inflatable bladder, positioned adjacent to the second inflatable bladder,
wherein the first, second and third inflatable bladders are positioned at least partially transverse to each other, and
wherein a substantial portion of the distal end of the bladder assembly includes the first inflatable bladder and a substantial portion of the proximal end of the bladder assembly includes the third inflatable bladder.

18. The assembly of claim 17, wherein the first inflatable bladder is smaller than the second inflatable bladder and the second inflatable bladder is smaller than the third inflatable bladder.

19. The assembly of claim 17, wherein at least two of the first, second and third inflatable bladders are attached to each other using at least one of gluing, stitching and zipping.

20. The assembly of claim 17, wherein the first, second and third inflatable bladders are physically coupled such that the second inflatable bladder overlaps a portion of the first inflatable bladder and the third inflatable bladder overlaps a portion of the second inflatable bladder.

21. The assembly of claim 17, wherein the first inflatable bladder is positioned inside the second inflatable bladder and the second inflatable bladder is positioned inside the third inflatable bladder.

22. A method of applying therapy to a limb, comprising:
applying a proximal bladder assembly on a proximal side of the limb about a joint,
applying a distal bladder assembly on a distal side of the limb about a joint, and
applying compression to a limb by first inflating the proximal bladder assembly and then inflating the distal bladder assembly.

23. The method of claim 22, wherein the proximal bladder assembly includes a plurality of inflatable bladders.

24. The method of claim 23, wherein inflating the proximal bladder assembly includes first inflating one or more of the plurality of inflatable bladders in a distal portion of the proximal bladder assembly and then inflating one or more of the plurality of inflatable bladders in a proximal portion of the proximal bladder assembly.

25. The method of claim 22, wherein the distal bladder assembly includes a plurality of inflatable bladders.

26. The method of claim 25, wherein inflating the distal bladder assembly includes first inflating one or more of the plurality of inflatable bladders in distal portion of the distal bladder assembly and then inflating one or more of the plurality of inflatable bladders in proximal portion of the distal bladder assembly.

27. The method of claim 22, comprising applying at least one of the proximal and distal bladder assemblies to at least one of a lower calf area, a mid-calf area, an upper calf area, a heel region, an ankle region in the area of the maleolus, an Achilles area, a distal metatarsal area, a navicular region, a region proximal to a navicular region and distal to a maleolus region.

28. The method of claim 22, wherein each of the proximal and distal bladder assemblies include three inflatable fluid bladders.

29. The method of claim 22, comprising deflating the proximal bladder assembly after inflating the proximal bladder assembly.

30. The method of claim 29, comprising deflating the proximal bladder assembly while inflating the distal bladder assembly.

31. The method of claim 29, comprising deflating the proximal bladder assembly after inflating the distal bladder assembly.

32. The method of claim 22, comprising deflating the distal bladder assembly after inflating the distal bladder assembly.

33. The method of claim 32, comprising deflating the proximal bladder assembly after deflating the distal bladder assembly.

34. The method of claim 22, comprising first deflating the proximal bladder assembly and then deflating the distal bladder assembly.

35. The method of claim 22, comprising deflating the proximal bladder assembly.

36. The method of claim 35, wherein the proximal bladder assembly includes a plurality of inflatable bladders.

37. The method of claim 36, wherein deflating the proximal bladder assembly includes first deflating one or more of the plurality of inflatable bladders in a distal portion of the proximal bladder assembly and then deflating one or more of the plurality of inflatable bladders in a proximal portion of the proximal bladder assembly.

38. The method of claim 22, comprising deflating the distal bladder assembly.

39. The method of claim 38, wherein the distal bladder assembly includes a plurality of inflatable bladders.

40. The method of claim 39, wherein deflating the distal bladder assembly includes first deflating one or more of the plurality of inflatable bladders in a distal portion of the distal bladder assembly and then deflating one or more of the plurality of inflatable bladders in a proximal portion of the distal bladder assembly.

41. The method of claim 22, comprising repeating application of compression until a target level is reached.

42. The method of claim 41, wherein the target level includes at least one of a number of cycles of compression, a time limit, a user-selected stopping point and a therapist selected stopping point.

43. The method of claim 22, wherein the limb includes at least one of a foot, lower leg, upper leg, arm, wrist, thigh, hand and finger.
